(19) United States
(12) Patent Application Publication
(10) Pub. No.: US 2026/0301447 A1
(43) Pub. Date: Oct. 1, 2026

(54) METHOD AND APPARATUS FOR SEMANTIC SEGMENTATION OF SCANNING SCENES BASED ON TEMPORAL INFORMATION FUSION

(71) Applicant: SHINNING 3D TECH CO., LTD., Hangzhou (CN)

(72) Inventors: Jialei WANG, Hangzhou (CN); Tengfei JIANG, Hangzhou (CN); Kaijia QIU, Hangzhou (CN); Jian ZHANG, Hangzhou (CN); Xiaobo ZHAO, Hangzhou (CN)

(21) Appl. No.: 19/474,916

(22) PCT Filed: Mar. 6, 2024
(86) PCT No.: PCT/CN2024/080410

§ 371 Date: Oct. 13, 2025

(30) Foreign Application Priority Data
Apr. 14, 2023 (CN) 202310401304.8

(51) Int. Cl. G06V 20/70; G06V 10/56; G06V 10/82

(52) U.S. Cl. CPC G06V 20/70; G06V 10/56; G06V 10/82

(57) ABSTRACT

Embodiments of the present disclosure relate to a method and apparatus for semantic segmentation of scanning scenes based on temporal information fusion. The method may include: obtaining current image data to be processed, wherein the current image data to be processed includes a current color image frame to be processed and a corresponding depth image frame; selecting preceding M frames of images to be processed from preceding N frames of images to be processed based on a pose matrix of the current image data to be processed, wherein N and M are positive integers and M is less than or equal to N; obtaining a semantic segmentation result corresponding to the current image data to be processed by inputting the current color image frame to be processed, the corresponding depth image frame, and the preceding M frames of image to be processed into a semantic segmentation model for processing. By adopting the above technical solution, the segmentation accuracy of the scanning scene is improved by fusing multi-frame temporal information, thereby eliminating noise information in single-frame scanning data based on single-frame semantic segmentation results and improving the modeling speed and effect of the 3D model.

### CROSS-REFERENCE TO RELATED APPLICATIONS

The present application claims the priority of Chinese Patent Application No. 202310401304.8, filed in the CNIPA on Apr. 14, 2023, with the title “Method and Device for Semantic Segmentation of Scanning Scenes Based on Temporal Information Fusion”, which is incorporated by reference in its entirety.

### TECHNICAL FIELD

The present disclosure generally relate to the technical field of scanning processing, more specifically, to a method and device for semantic segmentation of scanning scenes based on temporal information fusion.

### BACKGROUND

Generally, there may be many uninterested regions (for example, non-rigid regions, such as buccal side) during 3D reconstruction of teeth in intraoral scenes, which may affect the 3D reconstruction. It may improve speed and efficiency of the 3D reconstruction by performing semantic segmentation on a single frame of image and removing the uninterested regions.

In related technologies, neural networks may be used to make separate predictions for each single frame of scanned image. Due to the extremely complex intraoral environment and the limitation of the visible range of the camera lens, the texture information of the buccal side and gums may be very similar in some single-frame scanned images, which may make it difficult to accurately segment the texture information of the buccal side and gums in the single-frame scanned image. Thus, The above-mentioned method may result in low accuracy of the segmentation results, which may introduce a lot of noise to the reconstruction process of the tooth model and seriously affect the speed and effect of 3D reconstruction.

### SUMMARY

In order to address or at least partially address the technical problem described above, the present disclosure provides a method and apparatus for semantic segmentation of scanning scenes based on temporal information fusion.

Embodiments of the present disclosure provide a method for semantic segmentation of scanning scenes based on temporal information fusion, the method may include: obtaining current image data to be processed; wherein the current image data to be processed includes a current color image frame to be processed and a corresponding depth image frame; selecting preceding M frames of images to be processed from preceding N frames of images to be processed based on a pose matrix of the current image data to be processed; where N and M are positive integers and M is less than or equal to N; obtaining a semantic segmentation result corresponding to the current image data to be processed by inputting the current color image frame to be processed, the corresponding depth image frame and the preceding M frames of image to be processed into a semantic segmentation model.

Embodiments of the present disclosure also provide an apparatus for semantic segmentation of scanning scenes based on temporal information fusion, the apparatus may include: a first acquisition module configured to obtain current image data to be processed; wherein the current image data to be processed includes a current color image frame to be processed and a corresponding depth image frame; a selection module configured to select preceding M frames of images to be processed from preceding N frames of images to be processed based on a pose matrix of the current image data to be processed; where N and M are positive integers and M is less than or equal to N; a processing module configured to obtain a semantic segmentation result corresponding to the current image data to be processed by inputting the current color image frame to be processed, the corresponding depth image frame and the preceding M frames of image to be processed into a semantic segmentation model.

Embodiments of the present disclosure also provide an electronic device, which includes: a processor; a memory for storing executable instructions of the processor; the processor is configured to read the executable instructions from the memory and execute the instructions to implement the method for semantic segmentation of scanning scenes based on temporal information fusion provided by the embodiments of the present disclosure.

Embodiments of the present disclosure also provide a computer-readable storage medium, wherein the storage medium stores a computer program, and the computer program is used to execute the method for semantic segmentation of scanning scenes based on temporal information fusion provided by the embodiments of the present disclosure.

The scheme for semantic segmentation of scanning scene based on temporal information fusion provided by the embodiments of the present disclosure includes: obtaining current image data to be processed; wherein the current image data to be processed includes a current color image frame to be processed and a corresponding depth image frame; selecting preceding M frames of images to be processed from preceding N frames of images to be processed based on a pose matrix of the current image data to be processed; where N and M are positive integers and M is less than or equal to N; obtaining a semantic segmentation result corresponding to the current image data to be processed by inputting the current color image frame to be processed, the corresponding depth image frame and the preceding M frames of image to be processed into a semantic segmentation model.

### BRIEF DESCRIPTION OF THE DRAWINGS

The drawings, which are incorporated in and constitute a part of the specification, illustrate embodiments consistent with the disclosure and together with the specification serve to explain the principles of the disclosure.

In order to more clearly illustrate the embodiments of the present disclosure or the technical solutions in the prior art, the following will briefly introduce the accompanying drawings required in the description of the embodiments or the prior art. Obviously, for those of ordinary skill in the art, other drawings can also be obtained from the drawings without exerting creative labor.

FIG. 1 is a schematic flowchart of a method for semantic segmentation of scanning scenes based on temporal information fusion provided by embodiments of the present disclosure;

FIG. 2 is a schematic flowchart of another method for semantic segmentation of scanning scenes based on temporal information fusion provided by embodiments of the present disclosure;

FIG. 3a is a schematic diagram of a semantic segmentation model provided by embodiments of the present disclosure;

FIG. 3b is a schematic diagram of another semantic segmentation model provided by embodiments of the present disclosure;

FIG. 4 is a schematic diagram of another semantic segmentation model provided by embodiments of the present disclosure;

FIG. 5 is a schematic diagram of another semantic segmentation model provided by embodiments of the present disclosure;

FIG. 6 is a schematic structural diagram of an apparatus for semantic segmentation of scanning scenes based on temporal information fusion provided by embodiments of the present disclosure;

FIG. 7 is a schematic structural diagram of an electronic device provided by embodiments of the present disclosure.

### DETAILED DESCRIPTION

The following will describe the embodiments of the present disclosure with more details with reference to the drawings. Although the drawings show some certain embodiments of the present disclosure, it should be understood that the present disclosure can be implemented in various forms and should not be construed as being limited to the embodiments herein. On the contrary, the embodiments are provided for more thorough and complete understanding of the present disclosure. It should be understood that the drawings and embodiments of the present disclosure are only for illustrative purposes and are not intended to limit the protection scope of the present disclosure.

It should be understood that the various steps described in method implementations of the present disclosure can be executed in different orders and/or in parallel. In addition, the method implementations may include additional steps and/or omit the execution of the illustrated steps. The scope of the present disclosure is not limited in this regard.

The term “including” and its variants as used herein are open-ended inclusions, which means that “including but not limited to”. The term “based on” means “based at least in part on”. The term “one embodiment” means “at least one embodiment”; the term “another embodiment” means “at least one additional embodiment”; the term “some embodiments” means “at least some embodiments”. Relevant definitions of other terms will be given in the following description.

It should be noted that the concepts such as “first” and “second” mentioned in the present disclosure are only used to distinguish different apparatus, modules or units, and are not used to limit the order of functions performed by the apparatus, modules or units or their interdependencies.

It should be noted that the modifications of “a” and “a plurality of” mentioned in the present disclosure are illustrative rather than restrictive. Those skilled in the art should understand that unless clearly indicated otherwise in the context, they should be understood as “one or more”.

The names of messages or information interacted between multiple apparatus in the implementations of the present disclosure are only for illustrative purposes, and are not used to limit the scope of the messages or information.

In practical applications, in the field of oral medical, 3D reconstruction of tooth models is usually performed based on multi-view images. However, capturing some non-rigid soft tissues such as lips and buccal sides, or temporary medical items such as medical gloves and oral mirrors from certain perspectives may introduce a lot of noise into the reconstruction process of the tooth model, therefor seriously affecting the speed and effect of 3D reconstruction. The noise data in a single image can be eliminated by using a semantic segmentation model based on deep learning, thereby effectively improving the modeling process of the 3D model.

It can be understood that due to the limitation of the visible range of a single frame of the camera, for example, the textures of the buccal side and gingival areas of scanning data of the signal frame in the intraoral scene are very similar, making it difficult to distinguish them from the scanning data of the signal frame. The embodiments of the present disclosure may fuse multi-frame temporal information based on the correlation of the scanning sequence output by the intraoral scanning device; and it may also introduce the segmentation of the current single-frame scanning data based on history scanning data. This can effectively improve the accuracy of semantic segmentation in the intraoral scene, accurately remove non-rigid regions such as the buccal side, and retain regions with extremely similar textures such as mucous membranes and the palate, which can help dentists further analyze cases. That is, it may fuse multi-frame temporal information and introduce the segmentation of the current single-frame scanning data based on history scanning data, which can effectively improve the segmentation accuracy of regions such as mucous membranes and the palate, and enhance the efficiency and effect of 3D reconstruction in the intraoral scene.

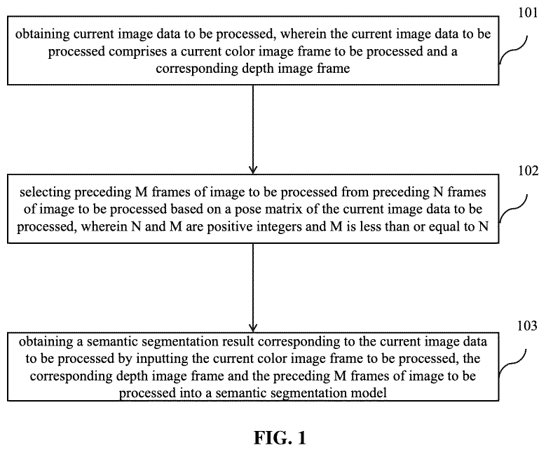

FIG. 1 is a schematic flowchart of a method for semantic segmentation of scanning scenes based on temporal information fusion provided by embodiments of the present disclosure. The method may be executed by an apparatus for semantic segmentation of scanning scenes based on temporal information fusion, wherein the apparatus may be implemented by software and/or hardware, and may generally be integrated into an electronic equipment. As shown in FIG. 1, the method may include following steps.

Step 101: obtaining current image data to be processed; wherein the current image data to be processed may include a current color image frame to be processed and a corresponding depth image frame.

The current image data to be processed may refer to the current color image frame to be processed obtained by a color camera in a scanning device and the corresponding depth image frame obtained by a depth camera. Specifically, the current color image frame to be processed and the corresponding depth image frame may be obtained by scanning and shooting an object in the same direction at the same position by the color camera and the depth camera respectively.

In the embodiment of the present disclosure, the current image data to be processed may refer to image data to be semantically segmented, including the current color image frame to be processed and the corresponding depth image frame. That is, performing semantic segmentation on fusion features of the current color image frame to be processed and the corresponding depth image frame can improve the accuracy of semantic segmentation.

Step 102: selecting preceding M frames of images to be processed from preceding N frames of images to be processed based on a pose matrix of the current image data to be processed, wherein N and M are positive integers and M is less than or equal to N.

In some embodiments, the pose matrix of the current image data to be processed may refer to a pose matrix corresponding to the current color image frame to be processed or a pose matrix corresponding to current depth image frame to be processed. The pose matrix of the current image data to be processed may be obtained by means such as point cloud matching using the Iterative Closest Point algorithm when scanning and acquiring the current image data to be processed.

In the embodiments of the present disclosure, there may be various ways to select the preceding M frames of images to be processed from the preceding N frames of images to be processed based on the pose matrix of the current image data to be processed. In some implementations, the current spatial vector and current translation value are determined based on the pose matrix of the current image data to be processed; the candidate spatial vector and candidate translation value corresponding to each frame of images to be processed among the preceding N frames of images to be processed are acquired; a first calculation value may be calculated based on the current spatial vector and each candidate spatial vector, and a second calculation value may be calculated based on the current translation value and each candidate translation value; and the preceding M frames of images to be processed are selected from the preceding N frames of images to be processed according to the first calculation value and the second calculation value.

In another implementations, the preceding M frames of images to be processed may be selected from the preceding N frames of images to be processed according to a calculation results, which is calculated by inputting the pose matrix of the current image data to be processed and pose matrix corresponding to each frame of image data to be processed among the preceding N frames of image data to be processed into a preset pose matrix similarity calculation formula directly.

The above two manners are only examples of selecting the preceding M frames of images to be processed from the preceding N frames of images to be processed based on the pose matrix of the current image data to be processed. The embodiments of the present disclosure do not specifically limit the implementation manner of selecting the preceding M frames of images to be processed from the preceding N frames of images a to be processed based on the pose matrix of the current image data to be processed.

Step 103: obtaining a semantic segmentation result corresponding to the current image data to be processed by inputting the current color image frame to be processed, the corresponding depth image frame, and the preceding M frames of images to be processed into a semantic segmentation model.

In some embodiments, the semantic segmentation model may be a pre-trained semantic segmentation model, which may directly output the semantic segmentation result corresponding to the current image data to be processed based on the current color image frame to be processed, the corresponding depth image frame, and the preceding M frames of images to be processed.

In the embodiments of the present disclosure, different semantic segmentation models adopt different processing manners. In some implementations, M+1 first feature matrices may be obtained by encoding the current color image frame to be processed, the corresponding depth image frame, and the preceding M frames of images to be processed respectively by M+1 encoders; a target feature matrix may be obtained by concatenating the M+1 first feature matrices by a concatenation network layer; a feature matrix to be segmented may be obtained by processing the target feature matrix by a multi-layer perceptron; and the semantic segmentation result may be obtained by decoding the feature matrix to be segmented by a decoder.

In other implementations, M+1 second feature matrices may be obtained by encoding the current color image frame to be processed, the corresponding depth image frame, and the preceding M frames of images to be processed respectively by M+1 encoders; a temporal feature matrix may be obtained by processing the M+1 second feature matrices by M+1 long-term memory network layers; and the semantic segmentation result may be obtained by decoding the temporal feature matrix by a decoder.

In another implementations, a target concatenation image may be obtained by concatenating the current color image frame to be processed, the corresponding depth image frame, and the preceding M frames of images to be processed by M+1 concatenation network layers; a target concatenation feature matrix may be obtained by processing the target concatenation image by a 3D convolutional neural network; and the semantic segmentation result may be obtained by decoding the target concatenation feature matrix.

The above three manners are only examples of obtaining the semantic segmentation result corresponding to the current image data to be processed by inputting the current color image frame to be processed, the corresponding depth image frame, and the preceding M frames of images to be processed into the semantic segmentation model. The embodiments of the present disclosure do not limit the specific implementation manner of obtaining the semantic segmentation result corresponding to the current image data to be processed by inputting the current color image frame to be processed, the corresponding depth image frame, and the preceding M frames of images to be processed into the semantic segmentation model.

The scheme of semantic segmentation of scanning scene based on temporal information fusion provided by the embodiments of the present disclosure may include obtaining the current image data to be processed; wherein the current image data to be processed includes the current color image frame to be processed and the corresponding depth image frame; selecting the preceding M frames of images to be processed from the preceding N frames of images to be processed based on the pose matrix of the current image data to be processed; wherein N and M are positive integers and M is less than or equal to N; and obtaining the semantic segmentation result corresponding to the current image data to be processed by inputting the current color image frame to be processed, the corresponding depth image frame, and the preceding M frames of images to be processed into the semantic segmentation model. By adopting the above technical solution, the segmentation accuracy of the scanning scene may be improved by fusing multi-frame temporal information, thereby eliminating the noise information in single-frame scanning data based on the semantic segmentation result of the signal frame, and improving the modeling speed and effect of the 3D model.

In some embodiments, a current scanning scene may also be obtained, and the semantic segmentation model may be determined based on the current scanning scene.

The current scanning scene may refer to requirements for real-time performance and accuracy of the current scanning. The real-time performance of the scanning may be represented by scanning time parameters, and the accuracy of the scanning may be represented by scanning result parameters (such as resolution, etc.). Different semantic segmentation models may be configured for different scanning scene, thereby determining the semantic segmentation model directly according to the current scanning scene during specific processing, which may further improve the efficiency of semantic segmentation for scanning scene based on temporal information fusion.

Specifically, in scanning and reconstruction scene, for example, a lot of non-rigid noise such as the buccal side may usually be introduced into the 3D reconstruction process of the intraoral tooth area, which may affect subsequent stitching, the speed and effect of reconstruction. The non-rigid regions such as the buccal and lingual sides may be removed through single-frame semantic segmentation, which may improve the efficiency of 3D reconstruction. However, due to the complex intraoral environment, the textures of the buccal side, gums, and palate are very similar, making it difficult to perform accurate semantic segmentation based on single-frame information alone.

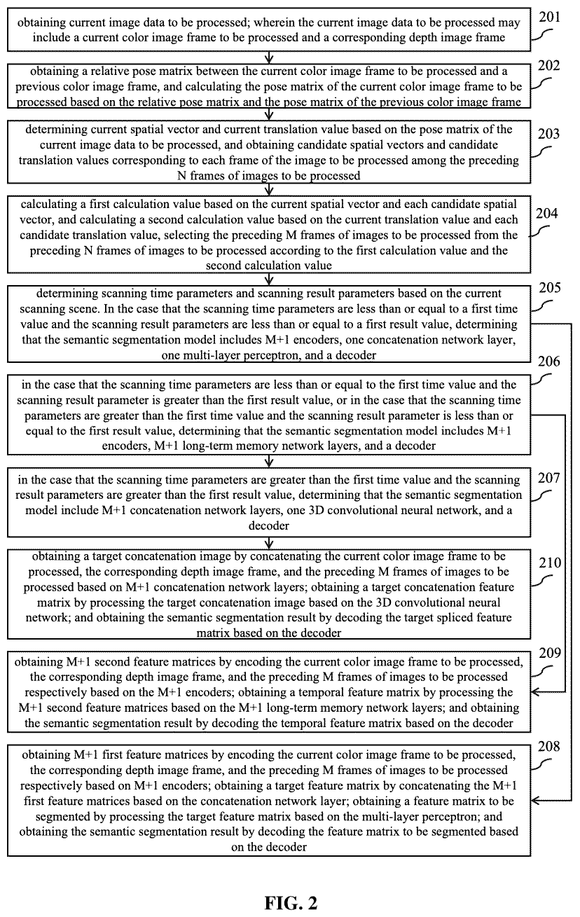

The method for semantic segmentation of scanning scene based on temporal information fusion in the embodiments of the present disclosure may improve the modeling speed and effect of 3D models by eliminating noise information in single-frame scanning data, and improve the accuracy of semantic segmentation in scanning scene by fusing multi-frame temporal information, thereby improving the efficiency of 3D modeling. Detailed description may be given with reference to FIG. 2.

FIG. 2 is a schematic flowchart of another method for semantic segmentation of scanning scenes based on temporal information fusion provided by embodiments of the present disclosure. On the basis of the above-mentioned embodiments, this embodiment further optimizes the above-mentioned method for semantic segmentation of scanning scenes based on temporal information fusion. As shown in FIG. 2, the method may include the following steps.

Step 201: obtaining current image data to be processed; wherein the current image data to be processed may include a current color image frame to be processed and a corresponding depth image frame.

It should be noted that Step 201 is the same as Step 101, and the details of the Step 201 may refer to the detailed description in Step 101, which will not be repeated here.

Step 202: obtaining a relative pose matrix between the current color image frame to be processed and a previous color image frame, and calculating the pose matrix of the current color image frame to be processed based on the relative pose matrix and the pose matrix of the previous color image frame.

In some embodiments, in the case that the previous color image frame is the first frame of color images, a pose matrix corresponding to the first color image frame may be determined based on a world coordinate system, which may be established based on the first color image frame.

Specifically, in a scanning scene, the pose matrix of each image frame may be obtained by point cloud matching. More specifically, the point cloud matching between two image frames is implemented by the Iterative Closest Point (ICP) algorithm. The pose matrix represents a relative relationship. A world coordinate system may be established based on the first frame of the scanned image, and the pose matrices of subsequent frames may be all calculated based on the previous frame. For example, when scanning an object to be scanned, the first color image is acquired, and a world coordinate system is established according to the first color image. Then, the second color image may be obtained by continuing to scan the object to be scanned, and the pose matrix of the second color image is RT1=rt1. Subsequently, the third color image may be obtained by continuing to scan the object to be scanned, and the pose matrix of the third color image is RT2=rt1*rt2. In some embodiments, rt1 represents a relative matrix between the first color image and the second color image, and rt2 represents a relative matrix between the second color image and the third color image. The first color image may be used to establish the world coordinate system, and then the point cloud matching of the previous and subsequent frames is performed. The pose matrix of the current frame color image is actually relative to the coordinate system of the first color image.

Step 203: determining current spatial vector and current translation value based on the pose matrix of the current image data to be processed, and obtaining candidate spatial vectors and candidate translation values corresponding to each frame of the image to be processed among the preceding N frames of images to be processed.

Step 204: calculating a first calculation value based on the current spatial vector and each candidate spatial vector, and calculating a second calculation value based on the current translation value and each candidate translation value, selecting the preceding M frames of images to be processed from the preceding N frames of images to be processed according to the first calculation value and the second calculation value.

Specifically, the pose matrix may be divided into rotation and translation, which is equivalent to a spatial vector V and a translation value T, wherein the similarity between spatial vectors V may be judged by calculating the cosine angle (the first calculation value), and the similarity of translation T may be directly judged by the square of the coordinate value (the second calculation value). Therefore, the preceding M frames of images to be processed may be determined from the preceding N frames of images to be processed by combining the first calculation value and the second calculation value. The preceding M frames of images to be processed may be determined based on the final similarity between image frames, which may be determined by means such as the sum of the first calculation value and the second calculation value or the weighted sum of corresponding weights.

Specifically, the embodiments of the present disclosure may fuse new feature information among multiple frames as much as possible and eliminate redundant information, which may further improve the segmentation effect. For example, in the case that only 5 frames of data may be input into the neural network model, 5 frames of images with relatively large changes in pose matrices may be selected from the pre-selected preceding N frames of data through pose matrices, and then be input into the semantic segmentation model, thereby ensuring that the input data may contain as rich temporal information as possible, and meeting user requirements.

Step 205: determining scanning time parameters and scanning result parameters based on the current scanning scene. In the case that the scanning time parameters are less than or equal to a first time value and the scanning result parameters are less than or equal to a first result value, determining that the semantic segmentation model includes M+1 encoders, one concatenation network layer, one multi-layer perceptron, and a decoder.

Step 206: in the case that the scanning time parameters are less than or equal to the first time value and the scanning result parameter is greater than the first result value, or in the case that the scanning time parameters are greater than the first time value and the scanning result parameter is less than or equal to the first result value, determining that the semantic segmentation model includes M+1 encoders, M+1 long-term memory network layers, and a decoder.

Step 207: in the case that the scanning time parameters are greater than the first time value and the scanning result parameters are greater than the first result value, determining that the semantic segmentation model include M+1 concatenation network layers, one 3D convolutional neural network, and a decoder.

Step 208: obtaining M+1 first feature matrices by encoding the current color image frame to be processed, the corresponding depth image frame, and the preceding M frames of images to be processed respectively based on M+1 encoders; obtaining a target feature matrix by concatenating the M+1 first feature matrices based on the concatenation network layer; obtaining a feature matrix to be segmented by processing the target feature matrix based on the multi-layer perceptron; and obtaining the semantic segmentation result by decoding the feature matrix to be segmented based on the decoder.

Step 209: obtaining M+1 second feature matrices by encoding the current color image frame to be processed, the corresponding depth image frame, and the preceding M frames of images to be processed respectively based on the M+1 encoders; obtaining a temporal feature matrix by processing the M+1 second feature matrices based on the M+1 long-term memory network layers; and obtaining the semantic segmentation result by decoding the temporal feature matrix based on the decoder.

Step 210: obtaining a target concatenation image by concatenating the current color image frame to be processed, the corresponding depth image frame, and the preceding M frames of images to be processed based on M+1 concatenation network layers; obtaining a target concatenation feature matrix by processing the target concatenation image based on the 3D convolutional neural network; and obtaining the semantic segmentation result by decoding the target spliced feature matrix based on the decoder.

In the embodiment of the present disclosure, after obtaining the M+1 first feature matrices or the M+1 second feature matrices, the method further includes: obtaining the pose matrices corresponding to the current color image frame to be processed, the corresponding depth image frame, and the preceding M frames of images to be processed; obtaining M+1 first feature matrices to be processed by concatenating each first feature matrix with the corresponding pose matrix; the step of obtaining the target feature matrix by concatenating the M+1 first feature matrices based on the concatenation network layer may include: obtaining the target feature matrix by concatenating the M+1 first feature matrices to be processed based on the concatenation network layer; or, obtaining M+1 second feature matrices to be processed by concatenating each second feature matrix with the corresponding pose matrix; the step of obtaining the temporal feature matrix by processing the M+1 second feature matrices based on M+1 long-term memory network layers may include: obtaining the temporal feature matrix by processing the M+1 second feature matrices to be processed based on M+1 long-term memory network layers.

Specifically, a fusion module may be input with information, which may be obtained by concatenating and merging the feature information of a single-frame image encoded by an encoder and the pose matrix corresponding to the single-frame image, and be used to learn automatically corresponding weights by the neural network. That is, in the case that the pose matrix information of the current frame image is relatively similar to the pose matrix information of previous single frames, the weight corresponding to the feature information of the single frame may be automatically reduced during the learning process. While accelerating the network, it may shift the focus of the neural network to the single-frame sequences with significantly different pose matrices.

Specifically, multiple single-frame data (color images and corresponding depth images) may be collected and annotated as training samples to establish a deep learning network model. The training samples may be input into the deep learning network model for training. Then, the current single-frame data to be semantically segmented and several previous single frames are input into the trained network model (i.e., the semantic segmentation model), which may provide the semantic segmentation mask map corresponding to the current single frame based on prediction results of the model. The embodiments of the present disclosure may effectively fuse temporal information and improve the accuracy of semantic segmentation.

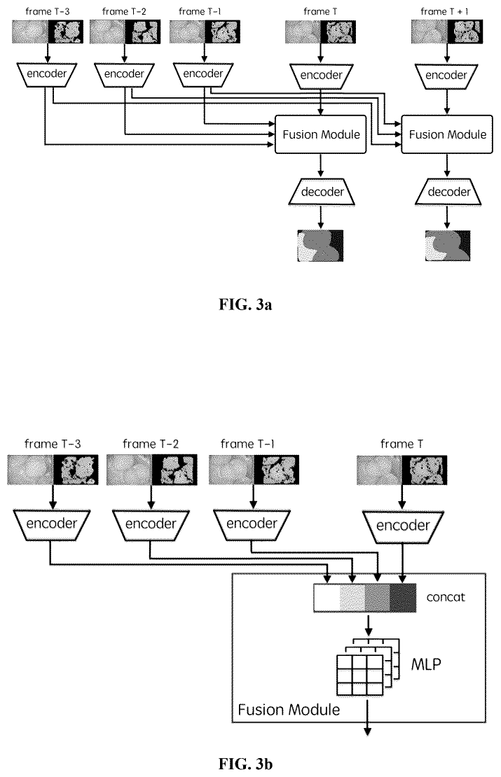

Specifically, as shown in FIG. 3a, each input single frame (including color image, corresponding depth image, and related pose information) may pass through an encoder module respectively for extracting feature information. The multi-frame feature information extracted previously and feature information of the current frame may be simultaneously input into the temporal information fusion module, which may include Long Short-Term Memory (LSTM) and the like, and may better fuse information between image frames. Finally, the result of feature fusion may be processed through a decoder module for restoring the image size and outputting the target mask area.

In some embodiments, the fusion module may extract temporal information in different ways. For example, as shown in FIG. 3b, an encode may be used to extract features from single-frame data (including, for example, color image frames and corresponding depth image frames such as framT-1, framT-2, framT-3, etc.), and then the extracted multi-frame feature information may be directly performed concat operation and input into an Multilayer Perceptron (MLP). This semantic segmentation model may operate relatively quickly and improve the efficiency of semantic segmentation.

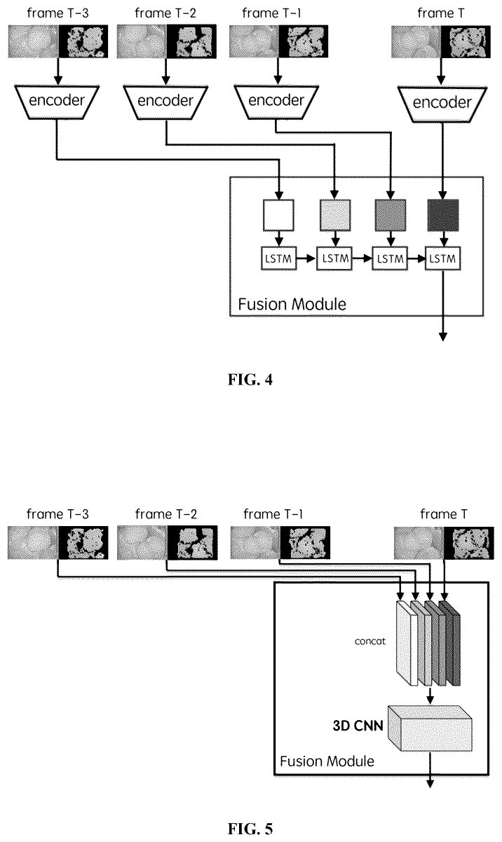

For example, as shown in FIG. 4, an encoder may be used to extract features from single-frame data (including, for example, color image frames and corresponding depth image frames such as framT-1, framT-2, framT-3, etc.), and then the temporal information between the multi-frame feature information may be extracted through recurrent neural networks, such as LSTM.

For example, as shown in FIG. 5, multi-frame data (including, for example, color image frames and corresponding depth image frames such as framT-1, framT-2, framT-3, etc.) may be directly concatenated and then input into a three-dimensional (3D) Convolutional Neural Networks (CNN), wherein the neural network may independently extract and learn the temporal information inter frame. This semantic segmentation model may achieve relatively good segmentation results.

Specifically, the selection of the semantic segmentation model may be determined after weighing specific hardware conditions and performance, such as resource consumption, training difficulty, and the amount of training data required. As resource consumption, training difficulty, and the required amount of training data increase in sequence, the corresponding accuracy also increases accordingly. For scenes with high real-time requirements, it may adopt the semantic segmentation model in step 205; for scenes with abundant hardware resources such as cloud servers, it may adopt the semantic segmentation model in step 207.

Thus, for intraoral scanning scenes, intraoral non-rigid regions may be removed through single-frame semantic segmentation, thereby improving the efficiency of 3D tooth reconstruction. By fusing multi-frame temporal information, the segmentation accuracy of regions with textures similar to the buccal side, such as the mucosa and palate, may be improved, as well as the stability of the segmentation effect of the single frame. It should be understood that fusing multi-frame temporal information may accurately segment uncertain regions in scanned images, such as image edges, thereby improving segmentation accuracy and ensuring the effectiveness of subsequent 3D reconstruction.

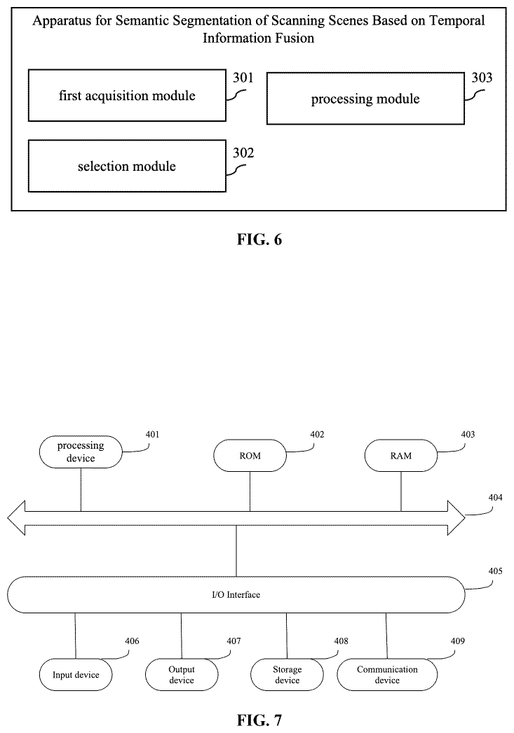

FIG. 6 is a schematic structural diagram of an apparatus for semantic segmentation of scanning scenes based on temporal information fusion provided by embodiments of the present disclosure. The apparatus may be implemented by software and/or hardware, and may generally be integrated into an electronic device. As shown in FIG. 6, the device may include: a first acquisition module 301, configured to obtain current image data to be processed, wherein the current image data to be processed may include a current color image frame to be processed and a corresponding depth image frame; a selection module 302, configured to determine preceding M frames of images to be processed from preceding N frames of images to be processed based on a pose matrix of the current image data to be processed, wherein N and M are positive integers and M is less than or equal to N; a processing module 303, configured to obtain a semantic segmentation result corresponding to the current image data to be processed by inputting the current color image frame to be processed, the corresponding depth image frame, and the preceding M frames of images to be processed into a semantic segmentation model.

Alternatively, the apparatus for semantic segmentation of scanning scenes based on temporal information fusion may further include: a second acquisition module configured to obtain a current scanning scene; a determination module configured to determine a semantic segmentation model based on the current scanning scene.

Alternatively, the apparatus for semantic segmentation of scanning scenes based on temporal information fusion may further include: a third acquisition module configured to obtain a relative pose matrix between the current color image frame to be processed and the previous color image frame; a calculation module configured to calculate the pose matrix of the current color image frame to be processed based on the relative pose matrix and the pose matrix of the previous color image frame; wherein in the case that the previous color image frame is the first frame of the color images, the pose matrix corresponding to the first color image frame is determined based on a world coordinate system, which may be established based on the first frame of the color image.

Alternatively, the selection module 302 may be specifically configured to: determine a current spatial vector and current translation value based on the pose matrix of the current image data to be processed; obtaining a candidate spatial vector and candidate translation values corresponding to each frame of the image to be processed among the preceding N frames of images to be processed; calculate a first calculation value based on the current spatial vector and each candidate spatial vector, and calculate a second calculation value based on the current translation value and each candidate translation value; determine the preceding M frames of images to be processed from the preceding N frames of images to be processed according to the first calculation value and the second calculation value.

Optionally, the determination module may be specifically configured to: determine scanning time parameters and scanning result parameters based on the current scanning scene; in the case that the scanning time parameter is less than or equal to a first time value and the scanning result parameter is less than or equal to a first result value, determining that the semantic segmentation model comprises M+1 encoders, one concatenation network layer, one multi-layer perceptron, and a decoder; in the case that the scanning time parameter is less than or equal to the first time value and the scanning result parameter is greater than the first result value, or in the case that the scanning time parameter is greater than the first time value and the scanning result parameter is less than or equal to the first result value, determining that the semantic segmentation model comprises M+1 encoders, M+1 long-term memory network layers, and a decoder; in the case that the scanning time parameter is greater than the first time value and the scanning result parameter is greater than the first result value, determining that the semantic segmentation model comprises M+1 concatenation network layers, one 3D convolutional neural network, and a decoder.

Alternatively, the semantic segmentation model may include M+1 encoders, one concatenation network layer, one multi-layer perceptron, and the decoder; the processing module may be specifically configured to: obtain M+1 first feature matrices by encoding the current color image frame to be processed, the corresponding depth image frame, and the preceding M frames of image to be processed respectively based on the M+1 encoders; obtain target feature matrices by concatenating the M+1 first feature matrices based on the concatenation network layer; obtain feature matrices to be segmented by processing the target feature matrices based on the multi-layer perceptron, and obtain the semantic segmentation result by decoding the feature matrices to be segmented based on the decoder.

Alternatively, the semantic segmentation model may include M+1 encoders, M+1 long-term memory network layers, and the decoder, the processing module may be specifically configured to: obtain M+1 second feature matrices by encoding the current color image frame to be processed, the corresponding depth image frame, and the preceding M frames of image to be processed respectively based on the M+1 encoders; obtain temporal feature matrices by processing the M+1 second feature matrices based on the M+1 long-term memory network layers; obtain the semantic segmentation result by decoding the temporal feature matrices based on the decoder.

Alternatively, the semantic segmentation model may include M+1 concatenation network layers, one 3D convolutional neural network, and the decoder, the processing module 303 may be specifically configured to: obtain a target concatenation image by concatenating the current color image frame to be processed, the corresponding depth image frame, and the preceding M frames of image to be processed based on the M+1 concatenation network layers; obtain a target concatenation feature matrix by processing the target concatenation image based on the 3D convolutional neural network; obtain the semantic segmentation result by decoding the target concatenation feature matrix based on the decoder.

Alternatively, after obtaining the M+1 first feature matrices or the M+1 second feature matrices, the processing module may be further configured to: obtain pose matrices corresponding to the current color image frame to be processed, the corresponding depth image frame, and the preceding M frames of image to be processed; obtain M+1 first feature matrices to be processed by concatenating each of the first feature matrices with respective pose matrix; obtaining target feature matrices by concatenating the M+1 first feature matrices based on the concatenation network layer comprises: obtaining the target feature matrices by concatenating the M+1 first feature matrices to be processed based on the concatenation network layer; or, obtain M+1 second feature matrices to be processed by concatenating each of the second feature matrices with respective pose matrix; obtaining the temporal feature matrices by processing the M+1 second feature matrices based on the M+1 long-term memory network layers comprises: obtaining the temporal feature matrices by processing the M+1 second feature matrices to be processed based on the M+1 long-term memory network layers.

The apparatus for semantic segmentation of scanning scenes based on temporal information fusion provided by the embodiments of the present disclosure may execute the method for semantic segmentation of scanning scenes based on temporal information fusion provided by any embodiment of the present disclosure, and has corresponding functional modules and beneficial effects for implementing the method.

Embodiments of the present disclosure also provide a computer program product, including computer programs/instructions, which, when executed by a processor, implement the method for semantic segmentation of scanning scenes based on temporal information fusion provided by any embodiment of the present disclosure.

FIG. 7 is a schematic structural diagram of an electronic device provided by embodiments of the present disclosure. Referring specifically to FIG. 7, it shows a schematic structural diagram of an electronic device 400 suitable for implementing the embodiments of the present disclosure. The electronic device 400 in the embodiments of the present disclosure may include, but is not limited to, mobile terminals such as mobile phones, notebook computers, digital broadcast receivers, Personal Digital Assistants (PDAs), Tablet Computers (PADs), Portable Multimedia Players (PMPs), vehicle-mounted terminals (such as vehicle-mounted navigation terminals), etc., and fixed terminals such as digital TVs, desktop computers, etc. The electronic device shown in FIG. 7 is only an example, and should not impose any limitation on the functions and scope of use of the embodiments of the present disclosure.

As shown in FIG. 7, the electronic device 400 may include a processing device 401 (such as a central processing unit, a graphics processor, etc.), which may execute various suitable actions and processes according to programs stored in a read-only memory (ROM) 402 or programs loaded from a storage device 408 into a random access memory (RAM) 403. The RAM 403 may also store various programs and data required for the operation of the electronic device 400. The processing device 401, ROM 402, and RAM 403 may be connected to each other through a bus 404. An input/output (I/O) interface 405 may also be connected to the bus 404.

In general, the following devices may be connected to the I/O interface 405: input devices 406 including, for example, a touch screen, touch pad, keyboard, mouse, camera, microphone, accelerometer, gyroscope, etc.; output devices 407 including, for example, a liquid crystal display (LCD), speaker, vibrator, etc.; storage devices 408 including, for example, magnetic tape, hard disk, etc.; and a communication device 409. The communication device 409 may allow the electronic device 400 to perform wireless or wired communication with other devices to exchange data. Although FIG. 7 shows the electronic device 400 with various devices, it should be understood that it is not required to implement or have all the shown devices. Instead, more or fewer devices may be implemented or provided.

In particular, according to the embodiments of the present disclosure, the processes described above with reference to the flowcharts may be implemented as computer software programs. For example, the embodiments of the present disclosure include a computer program product, which includes computer programs carried on a non-transitory computer-readable medium, and the computer program may include program code for executing the method shown in the flowchart. In such embodiments, the computer program can be downloaded and installed from the network through the communication device 409, or installed from the storage device 408, or installed from the ROM 402. When the computer program is executed by the processing device 401, the above-mentioned functions defined in the method for semantic segmentation of scanning scenes based on temporal information fusion according to the embodiments of the present disclosure are executed.

It should be noted that the computer-readable medium mentioned above in the present disclosure may be a computer-readable signal medium, a computer-readable storage medium, or any combination. The computer-readable storage medium may be, for example, but not limited to, an electrical, magnetic, optical, electromagnetic, infrared, or semiconductor system, apparatus, or device, or any combination of the above. More specific examples of the computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that includes or stores programs, which may be used by or in conjunction with an instruction execution system, apparatus, or device. In the present disclosure, the computer-readable signal medium may include data signals propagated in a baseband or as part of a carrier wave, in which computer-readable program code is carried. The propagated data signal may take various forms, including but not limited to electromagnetic signals, optical signals, or any suitable combination of the above. The computer-readable signal medium may also be any computer-readable medium other than the computer-readable storage medium, and the computer-readable signal medium may send, propagate, or transmit programs used by or in conjunction with the instruction execution system, apparatus, or device. The program code included in the computer-readable medium may be transmitted via any appropriate medium, including but not limited to: an electric wire, an optical cable, radio frequency (RF), etc., or any suitable combination of the above.

In some implementations, clients and servers may communicate using any currently known or future-developed network protocols such as Hyper Text Transfer Protocol (HTTP), and may be interconnected with any form or medium of digital data communication (for example, communication networks). Examples of communication networks may include local area networks (“LAN”), wide area networks (“WAN”), the Internet (for example, the Internet), and peer-to-peer networks (for example, ad hoc peer-to-peer networks), as well as any currently known or future-developed networks.

The above-mentioned computer-readable medium may be included in the above-mentioned electronic device; it may also exist independently and not be assembled into the electronic device.

The above-mentioned computer-readable medium may carry one or more programs. When executing the one or more programs, the electronic device may: obtain current image data to be processed, wherein the current image data to be processed comprises a current color image frame to be processed and a corresponding depth image frame; selecting preceding M frames of image to be processed from preceding N frames of image to be processed based on a pose matrix of the current image data to be processed, wherein N and M are positive integers and M is less than or equal to N; obtaining a semantic segmentation result corresponding to the current image data to be processed by inputting the current color image frame to be processed, the corresponding depth image frame and the preceding M frames of image to be processed into a semantic segmentation model.

Computer program code for performing operations of the present disclosure may be written in one or more programming languages, or combinations thereof, which may include but not limited to object-oriented programming languages such as Java, Smalltalk, and C++, as well as conventional procedural programming languages such as the “C” language or similar programming languages. The program code may execute entirely on computers of the user, partly on the computer of the user, as a stand-alone software package, partly on the computer of the user and partly on a remote computer, or entirely on the remote computer or server. In the cases involving the remote computer, the remote computer may be connected to the computer of the user through any type of network, including a local area network (LAN) or a wide area network (WAN), or may be connected to an external computer (for example, through an Internet connection using an Internet service provider).

The flowcharts and block diagrams in the drawings may illustrate the possible architectures, functions, and operations of systems, methods, and computer program products according to various embodiments of the present disclosure. In this regard, each block in the flowcharts or block diagrams may represent a module, program segment, or portion of code that includes one or more executable instructions for implementing the specified logical function. It should also be noted that, in some alternative implementations, the functions noted in the blocks may occur in a different order than that noted in the drawings. For example, two blocks consecutively represented may actually execute substantially in parallel, or the two blocks may sometimes execute in the reverse order, which may depend on the functions involved. It should also be noted that each block in the block diagrams and/or flowcharts, and combinations of blocks in the block diagrams and/or flowcharts, may be implemented by special-purpose hardware-based systems that perform the specified functions or operations, or by combinations of special-purpose hardware and computer instructions.

The units involved in the embodiments described in the present disclosure may be implemented by means of software or hardware. In some embodiments, the name of the units does not constitute a limitation on the unit itself.

The functions described above in the present disclosure may be performed, at least in part, by one or more hardware logic components. For example, without limitation, exemplary types of the hardware logic components that may be used include: Field-Programmable Gate Arrays (FPGA), Application-Specific Integrated Circuits (ASIC), Application-Specific Standard Products (ASSP), System-on-Chip (SOC), Complex Programmable Logic Devices (CPLD), and so on.

In the context of the present disclosure, a machine-readable medium may be a tangible medium that may include or store programs for use by or in conjunction with an instruction execution system, apparatus, or device. A machine-readable medium may be a machine-readable signal medium or a machine-readable storage medium. Machine-readable media may include, but be not limited to, electronic, magnetic, optical, electromagnetic, infrared, or semiconductor systems, apparatuses, or devices, or any suitable combination of the foregoing. More specific examples of machine-readable storage media may include electrical connections based on one or more wires, portable computer disks, hard disks, Random Access Memory (RAM), Read-Only Memory (ROM), Erasable Programmable Read-Only Memory (EPROM or flash memory), optical fibers, portable compact disk read-only memory (CD-ROM), optical storage devices, magnetic storage devices, or any suitable combination of the foregoing.

According to one or more embodiments of the present disclosure, the present disclosure provides an electronic device, including: a processor; a memory for storing executable instructions of the processor; the processor is configured to read the executable instructions from the memory and execute the instructions to implement any one method for semantic segmentation of the scanning scenes based on temporal information fusion provided by the present disclosure.

According to one or more embodiments of the present disclosure, the present disclosure provides a computer-readable storage medium, wherein the storage medium stores a computer program, and the computer program is used to execute any one method for semantic segmentation of the scanning scenes based on temporal information fusion provided by the present disclosure.

The above description is merely a preferred embodiment of the present disclosure and an explanation of the technical principles applied. Those skilled in the art should understand that the scope of disclosure involved in the present disclosure is not limited to the technical solutions formed by the specific combination of the above technical features. At the same time, it should also cover other technical solutions formed by any combination of the above technical features or their equivalent features without departing from the above disclosed concept. For example, technical solutions formed by replacing the above features with technical features disclosed in the present disclosure (but not limited to) that have similar functions.

In addition, although the operations are depicted in a specific order, it should not be construed as requiring these operations to be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features described in the context of separate embodiments can also be implemented in combination in a single embodiment. Conversely, various features described in the context of a single embodiment can also be implemented in multiple embodiments individually or in any suitable subcombination.

Although the subject matter has been described using language specific to structural features and/or method logical actions, it should be understood that the subject matter defined in the appended claims is not necessarily limited to the specific features or actions described above. On the contrary, the specific features and actions described above are merely example forms of implementing the claims.

### INDUSTRIAL APPLICABILITY

The method for semantic segmentation of scanning scenes based on temporal information fusion provided by the present disclosure can improve the segmentation accuracy of scanning scenes by fusing multi-frame temporal information. Thereby, noise information in single-frame scanning data can be eliminated based on single-frame semantic segmentation results, and the modeling speed and effect of 3D models are enhanced, which has strong industrial applicability.

1. A method for semantic segmentation of scanning scenes based on temporal information fusion, comprising:
obtaining current image data to be processed, wherein the current image data to be processed comprises a current color image frame to be processed and a corresponding depth image frame;
selecting preceding M frames of image to be processed from preceding N frames of image to be processed based on a pose matrix of the current image data to be processed, wherein N and M are positive integers and M is less than or equal to N;
obtaining a semantic segmentation result corresponding to the current image data to be processed by inputting the current color image frame to be processed, the corresponding depth image frame and the preceding M frames of image to be processed into a semantic segmentation model.

2. The method for semantic segmentation of scanning scenes based on temporal information fusion according to claim 1, further comprising:
obtaining a current scanning scene;
determining the semantic segmentation model based on the current scanning scene.

3. The method for semantic segmentation of scanning scenes based on temporal information fusion according to claim 1, further comprising:
obtaining a relative pose matrix between the current color image frame to be processed and a previous color image frame;
calculating the pose matrix of the current color image frame to be processed based on the relative pose matrix and a pose matrix of the previous color image frame; wherein, in the case that the previous color image frame is a first frame of color image, the pose matrix corresponding to the first frame of the color image is determined based on a world coordinate system, which is established based on the first frame of the color image.

4. The method for semantic segmentation of scanning scenes based on temporal information fusion according to claim 1, wherein selecting the preceding M frames image to be processed from the preceding N frames image to be processed based on the pose matrix of the current image data to be processed comprises:
determining a current spatial vector and a current translation value based on the pose matrix of the current image data to be processed;
obtaining candidate spatial vectors and candidate translation values corresponding to each frame of the preceding N frames image to be processed respectively;
calculating a first calculation value based on the current spatial vector and each of the candidate spatial vectors, and calculating a second calculation value based on the current translation value and each of the candidate translation values;
determining the preceding M frames of image to be processed from the preceding N frames of image to be processed according to the first calculation value and the second calculation value.

5. The method for semantic segmentation of scanning scenes based on temporal information fusion according to claim 2, wherein determining the semantic segmentation model based on the current scanning scene comprises:
determining scanning time parameters and scanning result parameters based on the current scanning scene;
in the case that the scanning time parameter is less than or equal to a first time value and the scanning result parameter is less than or equal to a first result value, determining that the semantic segmentation model comprises M+1 encoders, one concatenation network layer, one multi-layer perceptron, and a decoder;
in the case that the scanning time parameter is less than or equal to the first time value and the scanning result parameter is greater than the first result value, or in the case that the scanning time parameter is greater than the first time value and the scanning result parameter is less than or equal to the first result value, determining that the semantic segmentation model comprises M+1 encoders, M+1 long-term memory network layers, and a decoder;
in the case that the scanning time parameter is greater than the first time value and the scanning result parameter is greater than the first result value, determining that the semantic segmentation model comprises M+1 concatenation network layers, one 3D convolutional neural network, and a decoder.

6. The method for semantic segmentation of scanning scenes based on temporal information fusion according to claim 5, wherein the semantic segmentation model comprises M+1 encoders, one concatenation network layer, one multi-layer perceptron, and a decoder; obtaining the semantic segmentation result corresponding to the current image data to be processed by inputting the current color image frame to be processed, the corresponding depth image frame and the preceding M frames of image to be processed into the semantic segmentation model comprises:
obtaining M+1 first feature matrices by encoding the current color image frame to be processed, the corresponding depth image frame, and the preceding M frames of image to be processed respectively based on the M+1 encoders;
obtaining target feature matrices by concatenating the M+1 first feature matrices based on the concatenation network layer;
obtaining feature matrices to be segmented by processing the target feature matrices based on the multi-layer perceptron, and obtaining the semantic segmentation result by decoding the feature matrices to be segmented based on the decoder.

7. The method for semantic segmentation of scanning scenes based on temporal information fusion according to claim 5, wherein the semantic segmentation model comprises M+1 encoders, M+1 long-term memory network layers, and a decoder, obtaining the semantic segmentation result corresponding to the current image data to be processed by inputting the current color image frame to be processed, the corresponding depth image frame and the preceding M frames of image to be processed into the semantic segmentation model comprises:
obtaining M+1 second feature matrices by encoding the current color image frame to be processed, the corresponding depth image frame, and the preceding M frames of image to be processed respectively based on the M+1 encoders;
obtaining temporal feature matrices by processing the M+1 second feature matrices based on the M+1 long-term memory network layers;
obtaining the semantic segmentation result by decoding the temporal feature matrices based on the decoder.

8. The method for semantic segmentation of scanning scenes based on temporal information fusion according to claim 5, wherein the semantic segmentation model comprises M+1 concatenation network layers, one 3D convolutional neural network, and a decoder, obtaining the semantic segmentation result corresponding to the current image data to be processed by inputting the current color image frame to be processed, the corresponding depth image frame and the preceding M frames of image to be processed into the semantic segmentation model comprises:
obtaining a target concatenation image by concatenating the current color image frame to be processed, the corresponding depth image frame, and the preceding M frames of image to be processed based on the M+1 concatenation network layers;
obtaining a target concatenation feature matrix by processing the target concatenation image based on the 3D convolutional neural network;
obtaining the semantic segmentation result by decoding the target concatenation feature matrix based on the decoder.

9. The method for semantic segmentation of scanning scenes based on temporal information fusion according to claim 6, wherein after obtaining the M+1 first feature matrices, the method further comprises:
obtaining pose matrices corresponding to the current color image frame to be processed, the corresponding depth image frame, and the preceding M frames of image to be processed;
obtaining M+1 first feature matrices to be processed by concatenating each of the first feature matrices with respective pose matrix;
obtaining target feature matrices by concatenating the M+1 first feature matrices based on the concatenation network layer comprises:
obtaining the target feature matrices by concatenating the M+1 first feature matrices to be processed based on the concatenation network layer.

10. (canceled)

11. An electronic device, comprising:
a processor;
a memory for storing executable instructions of the processor;
wherein the processor is configured to read the executable instructions from the memory and execute the instructions to:
obtain current image data to be processed, wherein the current image data to be processed comprises a current color image frame to be processed and a corresponding depth image frame;
select preceding M frames of image to be processed from preceding N frames of image to be processed based on a pose matrix of the current image data to be processed, wherein N and M are positive integers and M is less than or equal to N;
obtain a semantic segmentation result corresponding to the current image data to be processed by inputting the current color image frame to be processed, the corresponding depth image frame and the preceding M frames of image to be processed into a semantic segmentation model.

12. A non-transitory computer-readable storage medium, wherein the storage medium stores a computer program, and the computer program is configured to execute:
obtaining current image data to be processed, wherein the current image data to be processed comprises a current color image frame to be processed and a corresponding depth image frame;
selecting preceding M frames of image to be processed from preceding N frames of image to be processed based on a pose matrix of the current image data to be processed, wherein N and M are positive integers and M is less than or equal to N;
obtaining a semantic segmentation result corresponding to the current image data to be processed by inputting the current color image frame to be processed, the corresponding depth image frame and the preceding M frames of image to be processed into a semantic segmentation model.

13. The method for semantic segmentation of scanning scenes based on temporal information fusion according to claim 7, wherein after obtaining the M+1 second feature matrices, the method further comprises:
obtaining pose matrices corresponding to the current color image frame to be processed, the corresponding depth image frame, and the preceding M frames of image to be processed;
obtaining M+1 second feature matrices to be processed by concatenating each of the second feature matrices with respective pose matrix;
obtaining the temporal feature matrices by processing the M+1 second feature matrices based on the M+1 long-term memory network layers comprises:
obtaining the temporal feature matrices by processing the M+1 second feature matrices to be processed based on the M+1 long-term memory network layers.

14. The electronic device according to claim 11, the processor is further configured to:
obtain a current scanning scene;
determine the semantic segmentation model based on the current scanning scene.

15. The electronic device according to claim 11, the processor is further configured to:
obtain a relative pose matrix between the current color image frame to be processed and a previous color image frame;
calculate the pose matrix of the current color image frame to be processed based on the relative pose matrix and a pose matrix of the previous color image frame; wherein, in the case that the previous color image frame is a first frame of color image, the pose matrix corresponding to the first frame of the color image is determined based on a world coordinate system, which is established based on the first frame of the color image.

16. The electronic device according to claim 11, the processor is further configured to:
determine a current spatial vector and a current translation value based on the pose matrix of the current image data to be processed;
obtain candidate spatial vectors and candidate translation values corresponding to each frame of the preceding N frames image to be processed respectively;
calculate a first calculation value based on the current spatial vector and each of the candidate spatial vectors, and calculating a second calculation value based on the current translation value and each of the candidate translation values;
determine the preceding M frames of image to be processed from the preceding N frames of image to be processed according to the first calculation value and the second calculation value.

17. The electronic device according to claim 14, the processor is further configured to:
determine scanning time parameters and scanning result parameters based on the current scanning scene;
in the case that the scanning time parameter is less than or equal to a first time value and the scanning result parameter is less than or equal to a first result value, determine that the semantic segmentation model comprises M+1 encoders, one concatenation network layer, one multi-layer perceptron, and a decoder;
in the case that the scanning time parameter is less than or equal to the first time value and the scanning result parameter is greater than the first result value, or in the case that the scanning time parameter is greater than the first time value and the scanning result parameter is less than or equal to the first result value, determine that the semantic segmentation model comprises M+1 encoders, M+1 long-term memory network layers, and a decoder;
in the case that the scanning time parameter is greater than the first time value and the scanning result parameter is greater than the first result value, determine that the semantic segmentation model comprises M+1 concatenation network layers, one 3D convolutional neural network, and a decoder.

18. The electronic device according to claim 17, wherein the semantic segmentation model comprises M+1 encoders, one concatenation network layer, one multi-layer perceptron, and a decoder; the processor is further configured to:
obtain M+1 first feature matrices by encoding the current color image frame to be processed, the corresponding depth image frame, and the preceding M frames of image to be processed respectively based on the M+1 encoders;
obtain target feature matrices by concatenating the M+1 first feature matrices based on the concatenation network layer;
obtain feature matrices to be segmented by processing the target feature matrices based on the multi-layer perceptron, and obtaining the semantic segmentation result by decoding the feature matrices to be segmented based on the decoder.

19. The electronic device according to claim 17, wherein the semantic segmentation model comprises M+1 encoders, M+1 long-term memory network layers, and a decoder, the processor is further configured to:
obtain M+1 second feature matrices by encoding the current color image frame to be processed, the corresponding depth image frame, and the preceding M frames of image to be processed respectively based on the M+1 encoders;
obtain temporal feature matrices by processing the M+1 second feature matrices based on the M+1 long-term memory network layers;
obtain the semantic segmentation result by decoding the temporal feature matrices based on the decoder.

20. The electronic device according to claim 17, wherein the semantic segmentation model comprises M+1 concatenation network layers, one 3D convolutional neural network, and a decoder, the processor is further configured to:
obtain a target concatenation image by concatenating the current color image frame to be processed, the corresponding depth image frame, and the preceding M frames of image to be processed based on the M+1 concatenation network layers;
obtain a target concatenation feature matrix by processing the target concatenation image based on the 3D convolutional neural network;
obtain the semantic segmentation result by decoding the target concatenation feature matrix based on the decoder.

21. The electronic device according to claim 18, after obtaining the M+1 first feature matrices, the processor is further configured to:
obtain pose matrices corresponding to the current color image frame to be processed, the corresponding depth image frame, and the preceding M frames of image to be processed;
obtain M+1 first feature matrices to be processed by concatenating each of the first feature matrices with respective pose matrix;
obtaining target feature matrices by concatenating the M+1 first feature matrices based on the concatenation network layer comprises:
obtaining the target feature matrices by concatenating the M+1 first feature matrices to be processed based on the concatenation network layer.
